(19) United States
(12) Patent Application Publication
(10) Pub. No.: US 2017/0271114 A1
(43) Pub. Date: Sep. 21, 2017

(54) PRINTED MEMS SWITCH

(71) Applicant: NORTHROP GRUMMAN SYSTEMS CORPORATION, Falls Church, VA (US)

(72) Inventors: XING LAN, Huntington Beach, CA (US); Chunbo Zhang, Manhattan Beach, CA (US)

(21) Appl. No.: 15/073,372

(22) Filed: Mar. 17, 2016

(51) Int. Cl. H01H 49/00; H01H 59/00; H01H 1/00

(52) U.S. Cl. CPC H01H 49/00; H01H 1/0036; H01H 59/0009; H01H 2001/0052

(57) ABSTRACT

A method for fabricating an MEMS switch including providing a substrate and printing at least one metal bias electrode, at least one metal connection pad and at least one metal contact pad on the substrate. The method then prints a sacrificial layer on the substrate and over the at least one bias electrode, and prints a flexible beam structure on the sacrificial layer. The sacrificial layer is then removed by dissolving the sacrificial layer in a wet solution to release the beam structure so that the beam structure is spaced some distance from the at least one bias electrode and the contact pad.

### BACKGROUND

Field

This invention relates generally to a micro-electromechanical system (MEMS) switch and, more particularly, to a MEMS switch that is fabricated on a substrate using ink printing technologies.

Discussion

MEMS switches that are employed for high frequency RF applications are well known in the art. An RF MEMS switch generally operates by electrostatic attraction where a voltage potential provided between a bias electrode and a flexible metal beam displaces the beam to make electrical contact and close the switch. These types of MEMS electrostatic switches have a very fast switching time, near-zero power consumption, high isolation, good linearity, and a low insertion loss, which makes them desirable for various microwave and other applications, such as reconfigurable phased arrays, analog/digital signal control processing, switch-bit true time delay (TTD) devices, switch-bit phase shifters, switch-bit attenuators, wideband planar switch matrixes, etc.

MEMS switches are usually fabricated on a wafer using various wafer and semiconductor fabrication processes that typically have a fabrication and integration time that is relatively slow. Further, MEMS switches that are part of a large antenna substrate or microwave circuit board require additional fabrication steps to be integrated with the substrate or circuit.

A typical MEMS switch is designed to operate over billions of switching cycles. However, because the flexible beam in a MEMS switch is generally made of metal, this many cycles often leads to metal fatigue, where the beam may ultimately break before the end of the desired life of the switch. Further, although these types of devices have low power consumption they often require electrostatic actuation in the range of 30-80 V, which is a relatively high voltage. Also, there is a reliability concern with known MEMS switches because “stiction” could occur between the metal beam and the contact when the switch is closed, where when the electrostatic coupling is removed, the switch does not open.

### BRIEF DESCRIPTION OF THE DRAWINGS

FIG. 1 is a top view of a phased array aperture including MEMS switches;

FIG. 2 is an illustration of a printing machine for printing a MEMS switch;

FIGS. 3-8 are profile views showing processing steps for a printed a MEMS switch;

FIG. 9 is a profile view of a printed MEMS switch including a ladder electrode;

FIG. 10 is a profile view of a printed MEMS switch including a beam structure attached at both ends;

FIG. 11 is a profile view of another printed MEMS switch;

FIG. 12 is a top view of the MEMS switch shown in FIG. 11; and

FIG. 13 is a profile view of another printed MEMS switch including a beam structure attached at both ends.

### DETAILED DESCRIPTION OF THE EMBODIMENTS

The following discussion of the embodiments of the invention directed to a printed MEMS switch is merely exemplary in nature, and is in no way intended to limit the invention or its applications or uses.

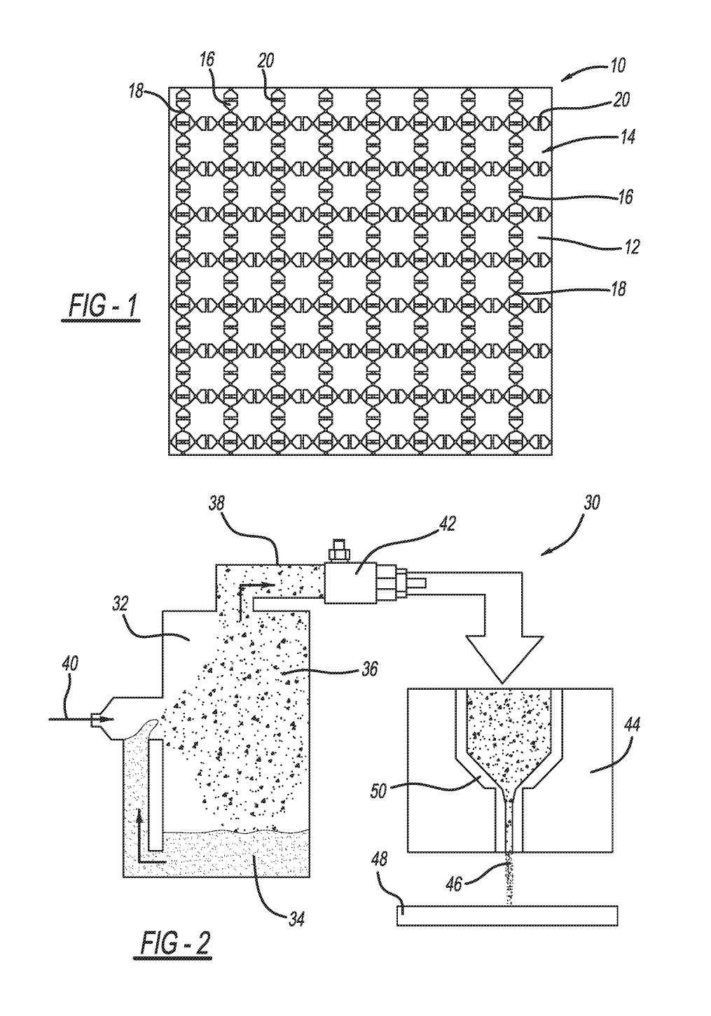

FIG. 1 is a top view of a wideband phased array aperture 10 for a phased array antenna system fabricated on a substrate 12. The aperture 10 includes a series of dual-polarized tight coupled dipole arrays 14 formed on the substrate 12 each including a series of antenna elements 16 electrically end-coupled together by conductive antenna element patches 18. Each of the antenna elements 16 includes a MEMS switch 20 that selectively turns on or turns off certain ones of the antenna elements 16 to connect the antenna elements 16 in a desirable configuration for beam steering and polarization switching purposes. High frequency RF MEMS switches used for this and other purposes are well known to those skilled in the art and offer a number of benefits as generally referred to above.

As will be discussed in detail below, the present invention proposes a highly integratable RF electrostatic MEMS switch that has various high frequency RF switching applications, such as in the phased array 10. Particularly, instead of being fabricated by known wafer semiconductor fabrication techniques, the MEMS switch of the present invention is fabricated by an ink printing process that provides certain advantages, such as a reduction in the voltage required for the electrostatic attraction and a reduction in stiction of the switch beam to a connector pad.

As will be discussed, the printed MEMS switch of the invention includes a beam structure that is either entirely made of a conductive polymer or mostly polymer based, where the polymer portion of the beam provides mechanical integrity and function, low weight, and non-stiction properties. The low Young's modulus of the polymer material reduces the electrostatic activation voltage. Further, by printing the MEMS switch, additional fabrication steps are not required to integrate the switch with large antenna substrates or microwave circuit boards. Additional advantages of a printed MEMS switch include scalability to large substrates, circuit boards and three-dimensional surfaces, low cost, simpler integration, quicker prototyping, faster design turn-around, and the ability to employ maskless green technologies.

As mentioned, the present invention is a MEMS switch that has been fabricated by an ink printing process. Various printing devices and apparatuses are known in the art that may be suitable for the fabrication process as described herein. FIG. 2 is an illustration of a printing machine 30, for example, the Optomec Inc. AJ300 model, that shows one non-limiting example of such a device, where the machine 30 uses synthesized ink. The machine 30 includes a chamber 32 that contains an ink solution 34, which is a mixture of the ink and particles of the specific material being deposited. For example, if the element being printed is a metal, then the ink solution 34 includes suitable metallic particles, such as aluminum, intermixed therein. A suitable ultrasonic or pneumatic atomizer (not shown) creates aerosol droplets 36 from the ink solution 34, where the aerosol droplets 36 are forced into a tube 38 by an inert gas introduced on line 40. The aerosol droplets 36 are sent through a virtual impactor (VI) 42 that bleeds off excess gas and low density droplets. The droplet cloud is densified before it is aerodynamically focused through a head 44 where the droplets are collimated and accelerated by a sheath gas 50 having an annular co-axial flow to be directed as a tight beam 46 onto a substrate 48. The position of the nozzle 44 is controlled so the ink solution is deposited at the desired location to allow layers of the ink solution to build up to form the thickness of the components as discussed herein. It is noted that although the discussion herein talks about depositing layers of various materials, each of the layers is actually defined by printing many layers of the same material.

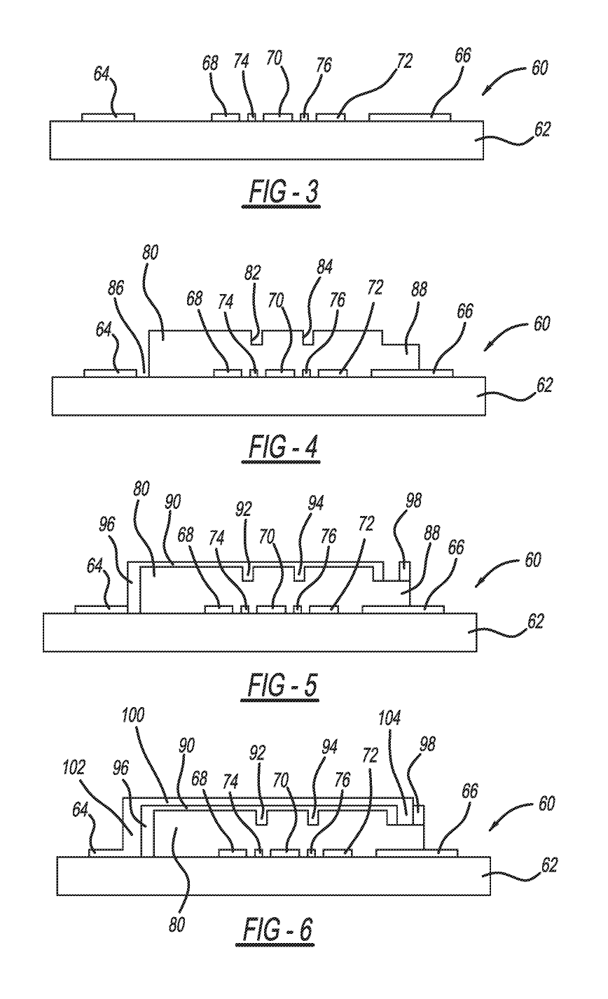

FIGS. 3-8 are profile views of a MEMS switch 60 at various points during fabrication of the switch 60 as produced, for example, by the printing machine 30. FIG. 3 shows the switch 60 after the printing process has deposited metal components on a substrate 62, where the printing machine 30 selectively provides the metal components at certain locations on the substrate 62 and to a certain thickness, such as 1 μm. The printing process allows the substrate 62 to be virtually any substrate for the particular application. One non-limiting example is Kapton, but the substrate 62 may be a semiconductor material, such as silicon, if the MEMS switch 60 is part of, for example, the phase antenna array 10. In this example for fabricating the MEMS switch 60, the metal printing process deposits a connection pad 64, a transmission line contact pad 66, electrostatic bias electrodes 68, 70 and 72 and optional stops 74 and 76, where the metal can be, for example, gold or silver. A thin patterned layer of a polymer (now shown) can be deposited on top of the metal layers if desired.

Next, the ink solution 34 in the chamber 32 is replaced with a sacrificial material solution, such as aluminum, copper, SU-8, etc., and a sacrificial layer 80 is printed on the substrate 62 over the bias electrodes 68, 70 and 72, the stops 74 and 76 and a portion of the pad 66 to a thickness of, for example, 1 μm, as shown. As will become apparent from the discussion below, the sacrificial layer 80 provides a support for fabrication of a beam structure, and will later be removed to provide a beam gap that allows the beam to be electrostatically moved. The printing process defines slots 82 and 84 in the sacrificial layer 80 for reasons that will become apparent from the discussion below. In this design, a gap 86 is defined between the sacrificial layer 80 and the connector 64 and a tip 88 of the sacrificial layer 80 has a thinner dimension than the remaining portion of the layer 80.

Once the sacrificial layer 80 has been printed on the substrate 62, a cantilever beam structure is then fabricated on the sacrificial layer 80. FIG. 5 shows a first step for providing the beam structure that includes printing a polymer layer 90 on the sacrificial layer 80 to a thickness of, for example, 1 μm, where the polymer layer 90 can be any suitable polymer for the purposes described herein, such as Teflon. As is apparent, the polymer layer 90 includes stops 92 and 94 formed in the slots 82 and 84, a side wall 96 formed in the gap 86, and a tab 98 formed at the edge of the tip 88.

The next step for providing the beam structure includes printing a conductive layer 100 over the polymer layer 90 to a thickness of, for example, 0.1-1 μm, as shown in FIG. 6, where the conductive layer 100 can be any suitable conductive polymer, such as PEDOT (poly(3,4-ethylenedioxythiophene)). The conductive layer 100 can also be a thin metal layer, such as gold. The conductive layer 100 includes a side wall 102 that makes electrical contact with the connector 64 and a contact portion 104 adjacent to the tab 98 on the sacrificial layer 90, as shown.

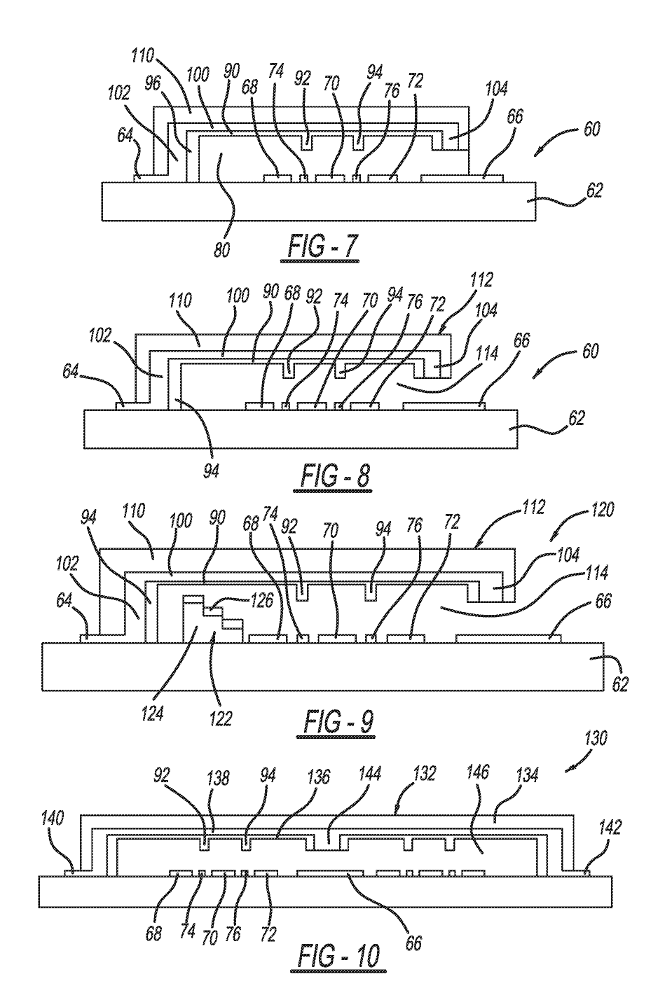

The next step for providing the beam structure includes printing another polymer layer 110, such as Teflon, on the metal layer 100 to a thickness of, for example, 1-3 μm, as shown in FIG. 7. The polymer layer 110 completely encloses the conductive layer 100 and makes contact with the connector 64 and the tab 98, as shown. Once the polymer layer 110 is printed by the printing machine 30, then the MEMS switch 60 is immersed in a suitable wet solution that dissolves the sacrificial layer 90 to release the beam structure, which is identified by reference numeral 112 in FIG. 8, and which defines a gap 114 between the beam structure 112 and the substrate 62. In one specific example to release the beam structure 112, the switch 60 is dipped in a removal solution for about 15 minutes, then quickly transferred to a de-ionized water solution rinse for about 20 minutes. The switch 60 is then transferred to an acetone for about 10 minutes and then to an IPA for about 10 minutes. The switch 60 is then transferred to a methanol solution for about 30 minutes or more, and then dried in air.

The beam structure 112 operates as a cantilever, where the contact portion 104 of the conductive layer 100 is positioned adjacent to and spaced from the pad 66. A bias voltage applied to the electrodes 68, 70 and 72 creates electrostatic coupling to the conductive layer 100 that draws the flexible beam structure 112 down so that the contact portion 104 contacts the pad 66 to make an electrical connection with the connector 64 and close the switch 60. When the beam structure 112 is drawn down, the stops 92 and 94 contact the stops 74 and 76 respectively, to provide mechanical support for the beam structure 112. The thickness of the polymer layers 90 and 110 provides mechanical function for the bending of the beam structure 112 and structural integrity. The polymer layers 90 and 110 not only provide the structural integrity for the beam structure 112, but also reduce the stiffness of the beam structure 112 so that less electrostatic force than traditional MEMS switch is required to flex the beam structure 112 to make electrical contact.

In an alternate embodiment, the beam structure can be a single conductive polymer layer. For example, in one non-limiting example, the layers 90, 100 and 110 are replaced with a single PEDOT layer.

The design of the MEMS switch 60 as shown in FIG. 8 is by way of one non-limiting example. FIG. 9 is a profile view of a MEMS switch 120 similar to the switch 60, where like elements are identified by the same reference number. In this design, a ladder electrode 122 is included that will be fabricated by the printing process between the steps discussed above for FIGS. 3 and 4. The ladder electrode 122 includes a polymer ladder section 124 on which metal electrodes 126 are printed, which provide electrostatic attraction closer to the conductive layer 100 to reduce the pull-down voltage of the beam structure 112. Because the electrodes 126 are closer to the conductive layer 100 than the electrodes 68, 70 and 72, a greater electrostatic force is provided at the same voltage so that voltage potential can be reduced to pull down the beam structure 112.

FIG. 10 is a profile view of a MEMS switch 130, where like elements to the switch 60 are identified by the same reference number. In this design, a fixed flexible beam structure 132 is employed instead of the cantilever beam structure 112. Particularly, the beam structure 132 includes outer polymer layers 134 and 136 and a center conductive layer 138 printed in the same manner as the beam structure 112, but the beam structure 132 is secured at both ends to connection pads 140 and 142, where a gap 146 is defined between the beam structure 132 and the substrate 62. A contact portion 144 contacts the pad 66 when the beam structure 132 is pulled down to make the electrical connection.

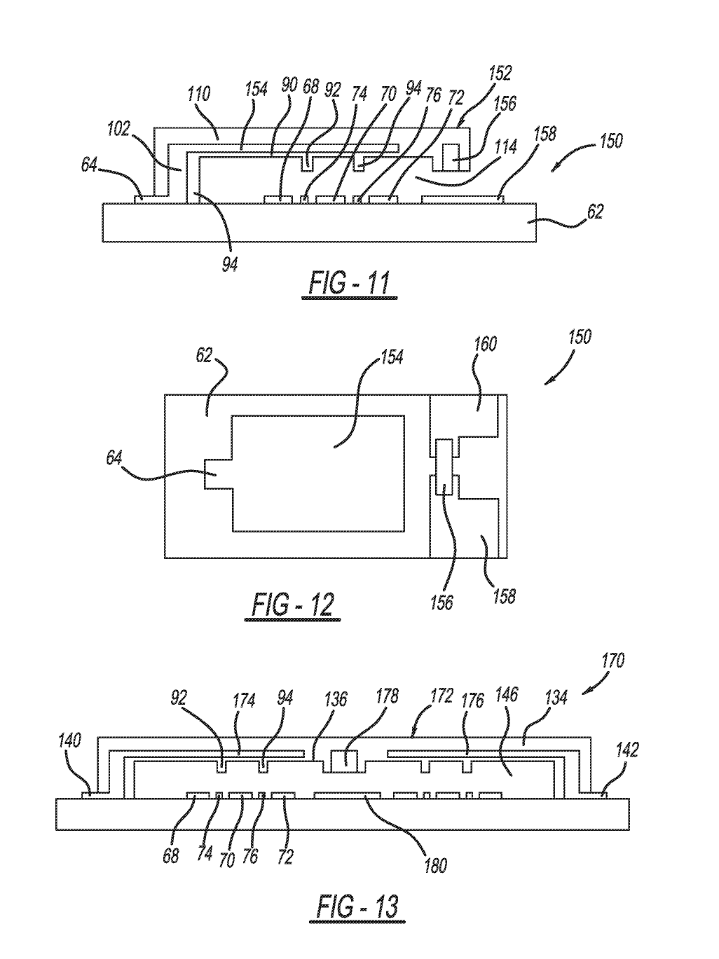

FIG. 11 is a profile view of a MEMS switch 150 similar to the switch 60, where like elements are identified by the same reference number. In this design, the beam structure 112 is replaced with a beam structure 152 where instead of printing the conductive layer 100, a conductive layer 154 and a contact portion 156 are printed that are similar to the conductive layer 100 and the contact portion 104, but are spaced apart and electrically isolated. Further, instead of printing the transmission line contact pad 66 on the substrate 62, two spaced apart transmission line contact pads 158 and 160 are printed on the substrate 62. FIG. 12 is a top view of the MEMS switch 150 with some of the beam structure layers removed for clarity. When a bias voltage applied to the bias electrodes 68, 70 and 72, an electrostatic attraction is made with the conductive layer 154 that draws the beam structure 152 down so that the contact portion 156 electrically bridges the gap between the contact pads 158 and 160 to make an electrical connection therebetween. The separation of the contact portion 156 and the conductive layer 154 allows a reduction in RF parasitics and can eventually push the operation of the MEMS switch 150 to a much higher operation frequency bands (higher cut-off frequency).

The same type of design can be provided for the fixed beam MEMS switch. Particularly, FIG. 13 is a profile view of a MEMS switch 170, where like elements to the switch 130 are identified by the same reference numeral. In this design, the fixed flexible beam structure 132 is replaced with a fixed flexible beam structure 172 including a first center conductive layer 174, a second center conductive layer 176 and a contact portion 178 that are all electrically isolated from each other. Further, the contact pad 66 is replaced with a pair of spaced apart contact pads 180. When the bias electrodes 68, 70 and 72 are energized, the beam structure 172 is pulled down so that the contact portion 178 makes an electrical connection between the spaced apart contact pads 180.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

1. A method for fabricating a micro-electromechanical system (MEMS) switch, said method comprising:
providing a substrate;
printing at least one bias electrode, at least one connection pad and at least one contact pad on the substrate;
printing a sacrificial layer on the substrate and over the at least one bias electrode and at least part of the contact pad;
printing a flexible beam structure on the sacrificial layer; and
removing the sacrificial layer to release the beam structure so that the beam structure is spaced some distance from the at least one bias electrode and the contact pad.

2. The method according to claim 1 wherein printing a beam structure includes printing a first polymer layer on the sacrificial layer, printing a conductive layer on the first polymer layer, and printing a second polymer layer on the conductive layer.

3. The method according to claim 2 wherein the first and second polymer layers are Teflon polymer layers.

4. The method according to claim 1 wherein printing a beam structure includes printing a conductive polymer layer.

5. The method according to claim 4 wherein the conductive polymer is PEDOT (poly(3,4-ethylenedioxythiophene)).

6. The method according to claim 1 wherein removing the sacrificial layer to release the beam structure includes dissolving the sacrificial layer in a wet solution.

7. The method according to claim 1 wherein the beam structure includes a first end and a second end where at least the first end of the beam structure is coupled to the at least one connection pad.

8. The method according to claim 7 wherein the beam structure is a cantilever structure, and wherein the first end of the beam structure is coupled to the at least one connection pad and the substrate and the second end of the beam structure is spaced from the at least one contact pad.

9. The method according to claim 7 wherein the at least one connection pad is a first connection pad and a second connection pad, and wherein the first end of the beam structure is fixed to the first connection pad and the second end of the beam structure is fixed to the second connection pad, said beam structure further including a contact portion that is positioned between the first and second ends of the beam structure.

10. The method according to claim 1 wherein printing at least one contact pad includes printing a first transmission line contact pad and a second transmission line contact pad that are spaced apart and electrically isolated from each other, and wherein printing a beam structure includes printing a conductive layer and a contact portion that are spaced apart and electrically isolated from each other, where the contact portion is operable to make an electrical connection between the first and second transmission line contact pads when the MEMS switch is closed.

11. The method according to claim 1 wherein printing at least one bias electrode includes printing a plurality of spaced apart bias electrodes.

12. The method according to claim 1 wherein printing at least one bias electrode includes printing a ladder electrode including polymer steps having a bias electrode thereon.

13. The method according to claim 1 further comprising printing at least one metal stop at the same time that the at least one bias electrode, the at least one connection pad and the contact pad are printed on the substrate, and wherein printing a flexible beam structure includes printing at least one stop that contacts the at least one metal stop when the MEMS switch is closed.

14. The method according to claim 1 wherein the MEMS switch is fabricated on a microwave circuit board along with microwave circuit components.

15. The method according to claim 14 wherein the microwave circuit board is a phased antenna array.

16. A method for fabricating a micro-electromechanical system (MEMS) switch, said method comprising:
providing a substrate;
printing a plurality of metal bias electrodes, at least one metal connection pad and at least one metal contact pad on the substrate;
printing a sacrificial layer on the substrate and over the plurality of bias electrodes and at least part of the contact pad;
printing a flexible beam structure including printing a first polymer layer on the sacrificial layer, printing a conductive layer on the first polymer layer, and printing a second polymer layer on the conductive layer; and
removing the sacrificial layer to release the beam structure by dissolving the sacrificial layer in a wet solution so that the beam structure is spaced some distance from the plurality of bias electrodes and the contact pad.

17. The method according to claim 16 wherein the beam structure includes a first end and a second end where at least the first end of the beam structure is coupled to the at least one connection pad.

18. The method according to claim 17 wherein the beam structure is a cantilever structure and the at least one connection pad is one connection pad, and wherein the first end of the beam structure is coupled to the connection pad and the substrate and the second end of the beam structure is spaced from the contact pad.

19. The method according to claim 17 wherein the at least one connection pad is a first connection pad and a second connection pad, and wherein the first end of the beam structure is fixed to the first connection pad and the second end of the beam structure is fixed to the second connection pad, said beam structure further including a contact portion that is positioned between the first and second ends of the beam structure.

20. A method for fabricating a micro-electromechanical system (MEMS) switch, said method comprising:
providing a substrate;
printing at least one bias electrode, at least one connection pad and a contact pad on the substrate;
printing a sacrificial layer on the substrate and over the at least one bias electrode and at least part of the contact pad;
printing a flexible beam structure on the sacrificial layer, said beam structure including a conductive polymer; and
removing the sacrificial layer to release the beam structure by dissolving the sacrificial layer in a wet solution so that the beam structure is spaced some distance from the at least one bias electrode and the contact pad.
